(19) United States
(12) Patent Application Publication
(10) Pub. No.: US 2021/0081898 A1
(43) Pub. Date: Mar. 18, 2021

(54) HUMAN RESOURCE MANAGEMENT SYSTEM AND METHOD THEREOF

(71) Applicants: INVENTEC (PUDONG) TECHNOLOGY CORPORATION, Shanghai City (CN); INVENTEC CORPORATION, Taipei City (TW)

(72) Inventors: Shih-Yi WU, Taipei City (TW); Trista Pei-Chun CHEN, Taipei City (TW); Wei-Chao CHEN, Taipei City (TW)

(73) Assignees: INVENTEC (PUDONG) TECHNOLOGY CORPORATION, Shanghai City (CN); INVENTEC CORPORATION, Taipei City (TW)

(21) Appl. No.: 16/695,005

(22) Filed: Nov. 25, 2019

(30) Foreign Application Priority Data
Sep. 12, 2019 (CN) 201910866925.7

(51) Int. Cl. G06Q 10/10; G06K 9/62; G06N 20/10; G06F 7/24

(52) U.S. Cl. CPC G06Q 10/105; G06K 9/6269; G06F 7/24; G06N 20/10; G06K 9/6256

(57) ABSTRACT

A human resource management method, comprising: obtaining a feature parameter associated with an employee; performing a prediction algorithm based on machine learning according to the feature parameter to output a human resource index; and performing a classification procedure to convert the human resource index to an understandable information.

### CROSS-REFERENCE TO RELATED APPLICATIONS

This non-provisional application claims priority under 35 U.S.C. § 119(a) on Patent Application No(s). 201910866925.7 filed in China on Sep. 12, 2019, the entire contents of which are hereby incorporated by reference.

### BACKGROUND

### 1. Technical Field

This disclosure relates to a field of human resource (HR) data analysis, especially to a system and method applied in human resource management.

### 2. Related Art

Traditionally, human resource (HR) department relies on peer reviews, personal interview, etc., to evaluate an employee for his or her current job satisfaction. And the same input may also be used to predict future job performance, resignation probability, job tenure (number of years in the job), and so on.

Assuming an employee's current levels of job satisfaction, resignation probability, or other desired HR index/result are to be predicted, an example of a traditional approach may be: assuming a specific factor (e.g. department where he/she serves) is relevant to the HR index, (e.g. resignation probability); averaging the historical HR indexes of all employees in the same factor; applying the historical HR index from the previous step for all employees with the same factor. However, the HR index obtained through the approach described above is not personalized for different individuals.

A more personalized approach may be adding an extra step of in-person interview to adjust the historical HR index for all employees with the same factor, thus producing a different HR index for each individual. However, such an extra step of in-person interview will likely introduce subjective bias.

In addition, there are limited resources in HR personnel. Therefore, the prediction or evaluation may not take extra inputs into consideration, such as job level, job classification, number of employees, resume and the description of job content. Even if all the inputs are reviewed by HR personnel, the evaluation or prediction done by human may not be objective enough. Therefore, there is a need for human resource management system, which takes into account of various inputs, weighs the relevance, discard unrelated inputs, objectively evaluates or predicts the desired HR index for each employee, and converts the HR index into a form that is understandable for the HR personnel.

### SUMMARY

According to one or more embodiment of this disclosure, a human resource management method, comprising: obtaining a feature parameter associated with an employee; performing a prediction algorithm based on machine learning according to the feature parameter to output a human resource index; and performing a classification procedure to convert the human resource index to an understandable information.

According to one or more embodiment of this disclosure, a human resource management system, comprising: a human resource database storing a plurality of feature parameters associated with each one of a plurality of employees; a storage device storing a plurality of commands; and one or more processing devices electrically connected to the human resource database and the storage device, with the one or more processing devices configured to execute the commands and initiate a plurality of operations, wherein the operations comprises: obtaining at least one of the feature parameters associated with one of the plurality of employees; performing a prediction algorithm based on machine learning according to the feature parameter to output a human resource index; and performing a classification procedure to convert the human resource index to an understandable information.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a human resource management system according to an embodiment of the present disclosure;

FIG. 2 is a flow chart of a human resource management method according to an embodiment of the present disclosure; and

FIG. 3 illustrates a histogram showing the statistics of levels of resignation possibility and numbers of employees.

### DETAILED DESCRIPTION

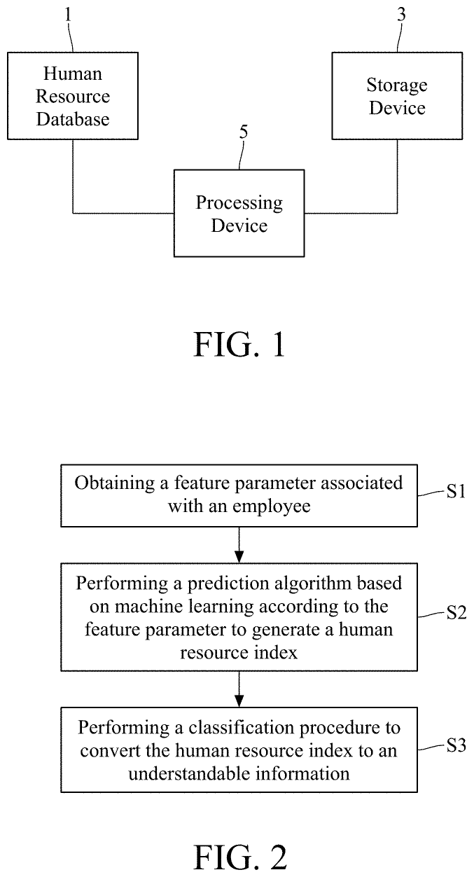

Please refer to FIG. 1, which is a block diagram of a human resource management system according to an embodiment of the present disclosure. As shown in FIG. 1, the described human resource (HR) management system 10 includes a human resource (HR) database 1, a storage device 3, and a processing device 5. The processing device 5 is electrically connected to the HR database 1 and the storage device 3.

The HR database 1 stores a plurality of feature parameters associated with every employee. The feature parameters can be in numerical form and text form, the former, for example, is tenure (a tenure parameter), job level (a job level parameter), education level (an education level parameter), age (an age parameter), previous performance appraisal and physical examination index; the latter, for example, is resume (a resume parameter), working experience (a working experience parameter) and keywords of work-related description.

The storage device 3 can store multiple commands, wherein the command, for example, is an understandable information generating command. The storage device 3 is, for example, a memory or a hard disk, the present disclosure is not limited to the hardware type of the storage device 3.

The processing device 5 reads and executes the commands stored in the storage device 3 to initiate multiple operations. For example, the processing device 5 executes operations to generate the understandable information when the command is the understandable information generating command. In one embodiment, the processing device 5, for example, is a microprocessor or a central processor, the present disclosure is not limited thereto. It is worth noticing that, the processing device 5 illustrated in FIG. 1 is merely an exemplary illustration, the number of the processing device 5 is not limited thereto. The operations initiated by the processing device 5 will be described in detail in conjunction with FIG. 2 as follows.

It is worth noticing that, in other embodiments of the present disclosure, the HR management system 10 can be presented in a software manner. For example, the HR management system 10 can be presented as a plug-in or an extension of the existing HR management software, or as a separate HR management software, to capture data from the HR database 1 or other HR management system and execute its operations.

Please refer to FIG. 2. FIG. 2 is a flow chart of a human resource management method according to an embodiment of the present disclosure.

Please refer to step S1: obtaining a feature parameter associated with an employee. To be more specific, the processing device 5 obtains the feature parameter from the HR database 1 associated with the employee that is selected by the HR personnel.

Please refer to step S2: performing a prediction algorithm based on machine learning according to the feature parameter to output a human resource index. The human resource index is referred to, for example, as: a resignation possibility index, a performance appraisal index, an expected tenure index or a level of satisfaction index. The following uses the resignation possibility index as an example.

The said prediction algorithm can integrate multiple feature parameters and predict the resignation possibility index. In practice, the prediction algorithm is, for example, an adaptive boost (AdaBoost) algorithm, a decision tree algorithm, or a random forest algorithm. Since the AdaBoost algorithm can automatically adjust the weights and filter the feature indexes, the feature parameters that are higher in discrimination level for the resignation possibility index will have higher weights during prediction, and the feature parameters that are lower in discrimination level will have lower weights or be discarded. Therefore, the following description uses AdaBoost algorithm as example.

The said machine learning is referring to pre-training. In the training phase, the AdaBoost algorithm is executed for training according to the feature parameters of the resigned employees and the still-employed employees recorded in the HR database 1 to learn how to filter and weigh the inputted feature parameters, and to output the corresponding human resource (HR) indexes (the resignation possibility index). In the online operation phase, that is, step S2, the processing device 5 generates a value (or vector) of the resignation possibility index according to the feature parameter of the selected employee by operating the trained AdaBoost algorithm.

Please refer to step S3: performing a classification procedure to convert the HR index to the understandable information. To be more specific, the classification procedure is executed to generate the understandable information according to one of a plurality of intervals that the HR index falls in. Assuming the resignation possibility (the value of the resignation possibility index) obtained in step S2 is 0.505278, the HR personnel is not able to directly obtain the actual information of this value. Therefore, there is a need to convert the predicted value of the resignation possibility index to the understandable information. The understandable information helps the HR personnel to understand the meaning of the predicted value. The understandable information can also be integrated into a workflow of HR management and be stored into the HR database 1 for future reference. In practice, the classification procedure can be used to convert the value of the resignation possibility index obtained from the AdaBoost algorithm into five levels: level 1 means “very likely to stay”; level 2 means “possible to stay”; level 3 means “neutral”; level 4 means “possible to quit”; and level 5 means “very likely to quit”. The five levels described above are the said understandable information.

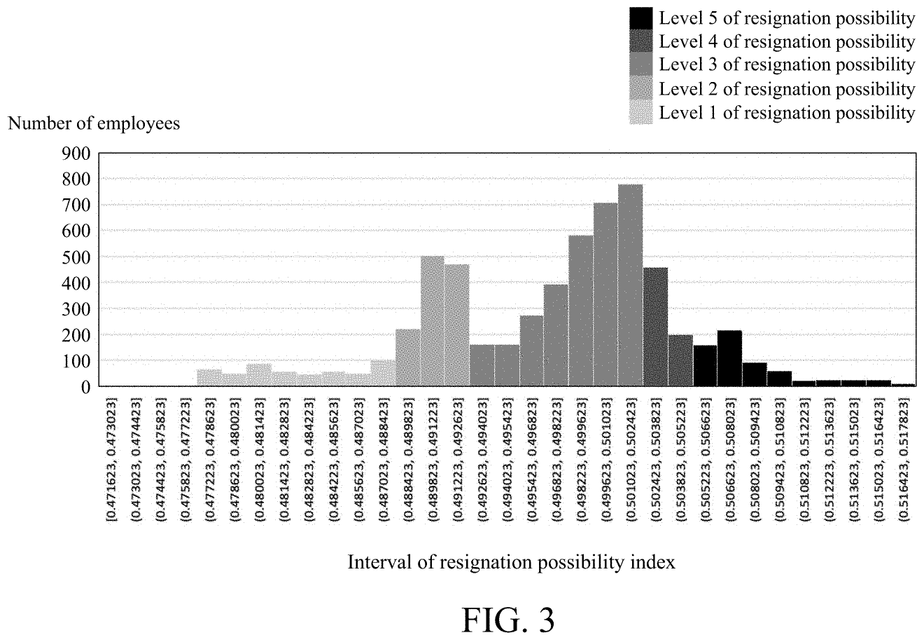

Please refer to FIG. 3. FIG. 3 illustrates a histogram showing the five levels of the resignation possibility index, every interval of the resignation possibility indexes and numbers of employees. Specifically, before converting the HR index to the understandable information (the five levels), boundary values of each level has to be determined. If the understandable information is classified as five levels, then there are four boundary values need to be determined. Therefore, the processing device 5 sorts multiple historical resignation possibility indexes from high to low that are obtained at the training phase, and labels the actual situation (whether the employee quits or not) corresponding to each historical resignation possibility index. The processing device 5 then adjusts one of the two boundary values of the four intervals, so that the prediction accuracies of level 1 and level 5 are higher than 80% (the prediction accuracy can also be adjusted according to needs). At the same time, the numbers of employees in these two levels are greater than a minimum interval cumulative number to avoid the boundary values of the intervals are adjusted to become too high or too low. So that when the subsequent classification procedure is actually being operated, the situation of no one being classified into level 1 or level 5 won't occur. Similarly, the processing device 5 adjusts the other two boundary values among the four boundary values so that the prediction accuracies of level 2 and level 4 are higher than 70% (the prediction accuracy can also be adjusted according to needs). At the same time, the cumulated numbers of employees in these two levels shouldn't be less than another minimum number. After the four boundary values are adjusted by the processing device 5, the interval of the resignation possibility index between level 2 and level 4 is classified as level 3.

According to the adjusting method described above, in practice, the boundary values of the levels obtained by the processing device 5 is approximately the first 10%, 30%, 70% and 90% of the resignation possibility indexes after sorting. Therefore, the processing device 5 sets the resignation possibility indexes corresponding to the first 10%, first 30%, first 70% and first 90% as the boundary values. The resignation possibility indexes that are higher than the top 10% will be converted to level 5. The top 10-30% resignation possibility indexes will be converted to level 4, and so on. The level distribution of all the historical resignation possibility indexes can be obtained, as shown in FIG. 3.

After obtaining the boundary values of the five levels described above, the resignation possibility indexes obtained in S2 can be converted to one of the five levels. Accordingly, supervisors or HR personnel can understand the working situation of each employee and take necessary steps for employees that are classified as “possible to quit” or “very likely to quit”. For example, the supervisors or HR personnel can actively invite interviews, provide more work resources, adjust salary, and so on.

In practice, one or more embodiments of the human resource management system according to the present disclosure, may adjust the previously described boundary values of the intervals according to the employment condition of all employees of each year, quarter or month to improve the accuracy of classification in step S3.

In view of the above description, compared to the traditional human resource management method, the human resource management method proposed by the present invention can use various forms of human resource feature parameters as training materials for machine learning. And the machine learning based prediction algorithm is cooperated with the classification procedure to generate information that is understandable to the human resource personnel. Therefore, the time for the human resource personnel to evaluate according to various feature parameters may be saved. Getting biased evaluation result of feature parameters of the same employee from human resource personnel may also be prevented. In addition to being used to predict the resignation level of each employee, the present disclosure may also be used to predict the expected tenure and the performance appraisal of a job seeker. Through the predicted understandable information, the effect of rapid screening of resumes may be achieved in human resource management, and the necessary measures may be taken adaptively to improve the satisfaction of the employers and employees. The converted understandable information may also save the storage space of the human resource database.

The present disclosure has been disclosed above in the embodiments described above, however it is not intended to limit the present disclosure. It is within the scope of the present disclosure to be modified without deviating from the essence and scope of it. It is intended that the scope of the present disclosure is defined by the following claims and their equivalents.

What is claimed is:

1. A human resource management method, comprising:
obtaining a feature parameter associated with an employee;
performing a prediction algorithm based on machine learning according to the feature parameter to output a human resource index; and
performing a classification procedure to convert the human resource index to an understandable information.

2. The human resource management method according to claim 1, wherein the classification procedure comprises:
sorting a plurality of historical human resource indexes and labeling a prediction result of each one of the historical human resource indexes;
adjusting boundary values of a plurality of intervals according to the historical human resource indexes, a prediction accuracy and a cumulative number of an interval; and
generating the understandable information according to a respect interval of the intervals where the human resource index falls in.

3. The human resource management method according to claim 1, wherein the feature parameter includes one or more of: a tenure parameter, a job level parameter, an education level parameter, an age parameter, a previous performance appraisal and resume parameter, a working experience parameter and a keyword of work-related description.

4. The human resource management method according to claim 1, wherein the prediction algorithm is an adaptive boost algorithm, a decision tree algorithm, or a random forest algorithm.

5. The human resource management method according to claim 1, wherein the human resource index includes at least one of: a resignation possibility index, a performance appraisal index, an expected tenure index and a level of satisfaction index.

6. A human resource management system, comprising:
a human resource database storing a plurality of feature parameters associated with each one of a plurality of employees;
a storage device storing a plurality of commands; and
one or more processing devices electrically connected to the human resource database and the storage device, with the one or more processing devices configured to execute the commands and initiate a plurality of operations, wherein the operations comprises:
obtaining at least one of the feature parameters associated with one of the plurality of employees;
performing a prediction algorithm based on machine learning according to the feature parameter to output a human resource index; and
performing a classification procedure to convert the human resource index to an understandable information.

7. The human resource management system according to claim 6, wherein the classification procedure comprises:
sorting a plurality of historical human resource indexes and labeling a prediction result of each one of the historical human resource indexes;
adjusting boundary values of a plurality of intervals according to the historical human resource indexes, a prediction accuracy and a cumulative number of an interval; and
generating the understandable information according to a respect interval of the intervals where the human resource index falls in.

8. The human resource management system according to claim 6, wherein the feature parameters include one or more of: a tenure parameter, a job level parameter, an education level parameter, an age parameter, a previous performance appraisal and resume parameter, a working experience parameter and a keyword of work-related description.

9. The human resource management system according to claim 6, wherein the prediction algorithm is an adaptive boost algorithm, a decision tree algorithm, or a random forest algorithm.

10. The human resource management system according to claim 6, wherein the human resource index at least one of: a resignation possibility index, a performance appraisal index, an expected tenure index and a level of satisfaction index.
